(19) United States
(12) Patent Application Publication
(10) Pub. No.: US 2026/0016448 A1
(43) Pub. Date: Jan. 15, 2026

(54) NOVEL PRE-STRESSED CONCRETE CYLINDER PIPE WITH PRE-EMBEDDED ACOUSTIC EMISSION SENSOR AND DISTRIBUTED OPTICAL FIBER, AND MANUFACTURING AND MONITORING METHODS THEREOF

(71) Applicants: NANJING HYDRAULIC RESEARCH INSTITUTE, Nanjing (CN); JILIN WATER NETWORK DEVELOPMENT GROUP, Changchun (CN); JILIN PROVINCE WATER RESOURCE AND HYDROPOWER CONSULTATIVE COMPANY OF P.R.CHINA, Changchun (CN); BEIJING HANJIANHESHAN PIPELINE CO., LTD, Beijing (CN)

(72) Inventors: Jun LU, Nanjing (CN); Guofu ZHAO, Nanjing (CN); Yongquan YU, Changchun (CN); Mulin YUAN, Changchun (CN); Xiangqian FAN, Nanjing (CN); Xintong WANG, Nanjing (CN); Pan MING, Nanjing (CN); Siyao WANG, Nanjing (CN); Zhongzhu CHEN, Changchun (CN); Xiaowen XIA, Beijing (CN)

(73) Assignees: NANJING HYDRAULIC RESEARCH INSTITUTE, Nanjing (CN); JILIN WATER NETWORK DEVELOPMENT GROUP, Changchun (CN); JILIN PROVINCE WATER RESOURCE AND HYDROPOWER CONSULTATIVE COMPANY OF P.R.CHINA, Changchun (CN); BEIJING HANJIANHESHAN PIPELINE CO., LTD, Beijing (CN)

(21) Appl. No.: 18/945,864

(22) Filed: Nov. 13, 2024

(30) Foreign Application Priority Data
Jul. 12, 2024 (CN) 202410934099.6

(51) Int. Cl. G01N 29/14; B28B 21/64; C04B 41/00; C04B 41/48; C04B 41/50; C04B 41/52; C04B 41/71; F16L 9/08; G01N 29/24

(52) U.S. Cl. CPC G01N 29/14; B28B 21/64; C04B 41/009; C04B 41/4853; C04B 41/5024; C04B 41/52; C04B 41/71; F16L 9/085; G01N 29/2475; G01N 2291/0231; G01N 2291/0258

(57) ABSTRACT

It discloses a new type of prestressed steel cylinder concrete pipe with pre embedded acoustic emission sensors and distributed optical fibers; the pipe is composed of an inner layer of concrete, a steel cylinder, a connecting piece, an outer layer of concrete, a prestressed steel wire, an inner mortar protective layer, a distributed optical fiber, an outer mortar protective layer, an acoustic emission sensor, and an external sensor fixing piece; the connecting piece is fixedly connected to the external sensor, and the acoustic emission sensor is located on the external sensor fixing piece and closely adheres to the outer mortar protective layer; a PCCP pipe with pre embedded acoustic emission sensor and distributed optical fiber of the present invention is used to fix the acoustic emission sensor by using a connection piece combined with an external sensor fixing piece.

### CROSS-REFERENCE TO RELATED APPLICATIONS

This application claims priority to Chinese Patent Application Ser. No. CN202410934099.6 filed on 12 Jul. 2024.

### TECHNICAL FIELD

The present invention relates to a novel pre-stressed concrete cylinder pipe with a pre-embedded acoustic emission sensor and a distributed optical fiber, and manufacturing and monitoring methods thereof, and belongs to the technical field of pre-stressed concrete pipe structures.

### BACKGROUND

Pre-stressed concrete cylinder pipe (PCCP) is a composite multi-purpose pipe, which has been widely used in the construction of various long-distance water diversion projects. Traditional PCCP structures may be divided into a lined type and an embedded type. The lined PCCP has a pipe core composed of a steel cylinder and a concrete lining, a circumferential pre-stressed steel wire is wound outside the steel cylinder, and then a cement mortar protective layer is manufactured. The embedded PCCP has a pipe core composed of a steel cylinder and concrete layers inside and outside the steel cylinder, a pre-stressed steel wire is wound outside a core concrete, and then a cement mortar protective layer is manufactured. The pre-stressed steel wire may generate a uniform initial pre-pressure on the pipe core concrete, so that the pipeline can resist a tensile stress caused by an internal water pressure.

In an operating process of the PCCP, the pre-stressed steel wire may break due to design, manufacturing, construction, environmental corrosion and other factors, resulting in a micro-crack in the mortar protective layer close to a broken wire. With the continuous deterioration of a stress situation close to the broken wire, multiple pre-stressed steel wires may break in the same area, which further reduces a bearing capacity of the pipeline, thus causing a pipe explosion accident. The pipe explosion of the PCCP will not only lead to the interruption of water supply of the pipeline, but also cause flood and public safety incidents, resulting in very significant economic losses.

It is of great significance to ensure the safe operation of the PCCP pipeline and grasp a wire breakage event of the pipeline and the corresponding position in real time for the real-time diagnosis and evaluation of structural health of the PCCP pipeline. Therefore, it is urgent to consider the optimization design of the traditional PCCP structure, so as to make the PCCP have a superior performance of identifying the wire breakage event and position.

### SUMMARY

Objective of invention: in order to overcome the defects in the prior art, the present invention provides a novel pre-stressed concrete cylinder pipe with a pre-embedded acoustic emission sensor and a distributed optical fiber, and manufacturing and wire breakage monitoring methods thereof, and according to the structure, the acoustic emission sensor is adhered and fixed to an outer wall of a pipeline through an internal connecting member and an external sensor fixing member, a wire breakage event is monitored in real time by the distributed optical fiber and the acoustic emission, and the accurate estimation of a wire breakage position is acquired through a joint positioning algorithm, so as to realize the real-time diagnosis and evaluation of a health state of the pipeline.

Technical solution: in order to solve the above technical problem, a manufacturing method of a novel pre-stressed concrete cylinder pipe with a pre-embedded acoustic emission sensor according to the present invention comprises the following steps:
S1: manufacturing a socket steel ring, a spigot steel ring and a steel cylinder used for connecting a pipeline joint, and welding the socket steel ring and the spigot steel ring to two ends of the steel cylinder;
S2: manufacturing a connecting member for connecting the steel cylinder with an external sensor fixing member, and fixing the connecting member on the steel cylinder;
S3: pouring a pipe core concrete;
S4: erecting a cured pipe core on a rotary platform, and winding a pre-stressed steel wire;
S5: roll-spraying an inner mortar protective layer;
S6: mounting a distributed optical fiber sensor;
S7: roll-spraying an outer mortar protective layer;
S8: roll-spraying an epoxy coal tar pitch anti-corrosive coating;
S9: manufacturing a fixing member for mounted an external sensor, and fixing the fixing member on the connecting member by a bolt; and
S10: after hoisting a pipeline to the site for positioning, coating a high-performance adhesive coupling agent on a surface of the acoustic emission sensor, mounting the acoustic emission sensor in the fixing member for adhesion and fixation, and subsequently connecting the acoustic emission sensor and the distributed optical fiber sensor with an acquisition instrument and an optical fiber demodulation instrument respectively, so that a pipeline wire breakage event is monitored in real time.

Preferably, the acoustic emission sensors are mounted on an upper side part of a pipe waist of a concrete pipe, and symmetrically arranged along an axial direction of the concrete pipe, and 5 to 9 acoustic emission sensors are mounted on a single pipeline.

The novel pre-stressed concrete cylinder pipe with the pre-embedded acoustic emission sensor and the distributed optical fiber consists of an inner concrete, the steel cylinder, the connecting member, an outer concrete, the pre-stressed steel wire, the inner mortar protective layer, the distributed optical fiber, the outer mortar protective layer, the acoustic emission sensor and the external sensor fixing member in sequence from a pipe interior to a pipe exterior, the connecting member is fixedly connected with the external sensor, and the acoustic emission sensor is located on the external sensor fixing member and closely attached to the external mortar protective layer.

A wire breakage monitoring method of the novel pre-stressed concrete cylinder pipe with the pre-embedded acoustic emission sensor and the distributed optical fiber comprises the following steps:
(a) carrying out a signal test before the pre-stressed concrete cylinder pipe leaves the factory, monitoring the pre-stressed concrete cylinder pipe by the distributed optical fiber and the acoustic emission device by simulating various environmental noises and wire breakage phenomena in a field monitoring process, establishing a signal sample database, and training a wire breakage signal identification model based on the database by a machine learning algorithm;
(b) after hoisting the pre-stressed concrete cylinder pipe to the site for mounting and positioning, coating the high-performance adhesive coupling agent on the surface of the acoustic emission sensor, mounting the acoustic emission sensor in the fixing member for adhesion and fixation, and subsequently connecting the acoustic emission sensor and the distributed optical fiber sensor with the acquisition instrument and the optical fiber demodulation instrument respectively;
(c) receiving in real time and synchronously recording signals of the optical fiber demodulation instrument and the acoustic emission acquisition instrument, inputting a signal of the distributed optical fiber acquired by monitoring into the wire breakage signal identification model for classification, and when the signal is identified as a wire breakage signal, recording an axial coordinate of a pipeline in which the signal appears;
(d) according to axial distances from the position to different sensors, selecting 10 sensors with the closest axial distances from the position, and sorting the sensors according to the axial distances from small to large;
(e) giving a trigger threshold range of [a, b] according to experience, and setting an initial trigger threshold as (a+b)/2;
(f) sequentially monitoring synchronously recorded and selected acoustic emission waves in a sensor sequence by using the set trigger threshold, and when a number of triggered sensors in the sensor sequence is less than 4, allowing that b=(a+b)/2, and the threshold is (a+b)/2; and when the number of the triggered sensors in the sensor sequence is greater than 6, allowing that a=(a+b)/2, and then updating the trigger threshold according to the formula (a+b)/2;
(g) repeating the step (f) until the number of the triggered sensors in the sensor sequence is 4 to 6, ending the adjustment of the trigger threshold, and recording current plane coordinates of each triggered sensor and P wave arrival time; and
(h) establishing the following mathematical model to solve a wire breakage position:

$$\begin{matrix}min {\sum }_{i = 1}^{n} \sqrt{{( {x}_{i} - {x}_{0} )}^{2} + {( {y}_{i} - {y}_{0} )}^{2}} - {v}_{p} ( {t}_{i} - {t}_{0} ) \\ s . t . \{ \begin{matrix}0 \leq {x}_{0} \leq {X}_{sup} \\ 0 \leq {y}_{0} \leq {Y}_{sup} \\ 0 \leq {v}_{p} \\ 0 \leq {t}_{0}\end{matrix}\end{matrix}$$

wherein: n is the number of the triggered acoustic emission sensors determined in the step (g), n is 4, 5 or 6, and vₚ is an acoustic emission wave velocity; (xᵢ, yᵢ) is a position of an i^{th} sensor, and tᵢ is P wave arrival time of the i^{th} sensor; to is an appearance moment of the wire breakage signal, and (x₀, y₀) is an actual wire breakage position; and Xₛᵤₚ is a circumferential extension length of the pipeline, Yₛᵤₚ is an axial length of the pipeline, and (x₀, y₀) is a specific broken wire acquisition position.

Beneficial effects: the present invention has the beneficial effects as follows.
(1) According to the novel PCCP pipe with the pre-embedded acoustic emission sensor and the distributed optical fiber and the manufacturing method thereof provided by the present invention, the acoustic emission sensor is fixed by a connection mode of matching the connecting member with the external sensor fixing member, and the connection mode is firmer and more reliable than a mode of directly adhering the acoustic emission sensor to the outer wall of the pipeline. Moreover, the external sensor fixing member has the functions of waterproof, moisture-proof, corrosion-proof and the like, and can ensure the normal operation of the acoustic emission sensor within specified service life to the maximum extent.
(2) According to the novel PCCP pipe with the pre-embedded acoustic emission sensor and the distributed optical fiber and the manufacturing method thereof provided by the present invention, the process is simple, and only production and mounting steps of the connecting member, the external sensor fixing member and the distributed optical fiber need to be added to a traditional PCCP structure production line, without causing too much influence on existing PCCP production lines.
(3) According to the novel PCCP pipe with the pre-embedded acoustic emission sensor and the distributed optical fiber provided by the present invention, compared with a traditional PCCP pipeline, the pre-embedded acoustic emission sensor and the distributed optical fiber may cooperate with the acoustic emission acquisition instrument and the optical fiber demodulation instrument respectively to monitor and feedback a possible wire breakage phenomenon in the pipeline in real time, which is convenient for engineering technicians to accurately evaluate a structural bearing capacity of the pipeline.
(4) According to the novel PCCP pipe with the pre-embedded acoustic emission sensor and the distributed optical fiber provided by the present invention, the wire breakage position is jointly positioned by the distributed optical fiber and the acoustic emission sensor. Compared with a monitoring mode of a singly distributed optical fiber, the method has higher positioning accuracy; compared with a monitoring mode of only arranging the acoustic emission sensor, the setting of the trigger threshold used in the method to solve the positioning problem is more reasonable, and the calculation efficiency is higher.

### BRIEF DESCRIPTION OF THE DRAWINGS

FIG. 1 is a sectional view of a structure of a pipeline along an axial direction in First Embodiment of the present invention;

FIG. 2 is a production flow chart of a novel PCCP pipe with a pre-embedded acoustic emission sensor and a distributed optical fiber provided by the present invention;

FIG. 3 is a schematic structural diagram of a connecting member in First Embodiment of the present invention;

FIG. 4 is a schematic diagram of a winding process of a pre-stressed steel wire in First Embodiment of the present invention;

FIG. 5 is a schematic structural diagram of an external sensor fixing member in First Embodiment of the present invention;

FIG. 6 is a schematic diagram of axial positioning of a wire breakage signal of the distributed optical fiber and arrangement of sensors in First Embodiment of the present invention;

FIG. 7 is a schematic diagram of accurate positioning of the wire breakage signal based on acoustic emission in First Embodiment of the present invention; and

FIG. 8 is a flow chart of determination of a number of the sensors.

### DETAILED DESCRIPTION

The present invention is further described hereinafter with reference to the drawings.

### First Embodiment

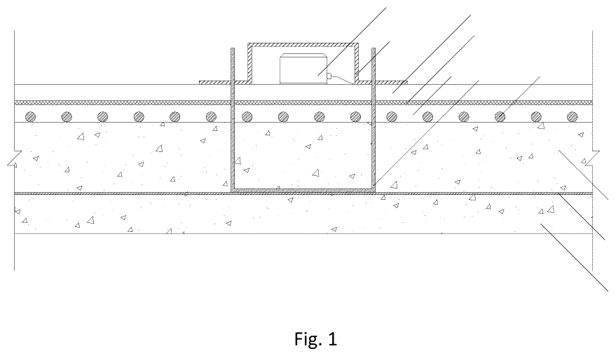

As shown in FIG. 1 to FIG. 8, the embodiment provides a manufacturing method of a novel pre-stressed concrete cylinder pipe with a pre-embedded acoustic emission sensor and a distributed optical fiber, wherein a length of a pipeline is 5 m, and a sectional view of a structure of the pipeline along an axial direction is as shown in FIG. 1. The novel pre-stressed concrete cylinder pipe consists of an inner concrete 1, a steel cylinder 2, a connecting member 3, an outer concrete 4, a pre-stressed steel wire 5, an inner mortar protective layer 6, the distributed optical fiber 7, an outer mortar protective layer 8, the acoustic emission sensor 9 and an external sensor fixing member 10 in sequence from a pipe interior to a pipe exterior.

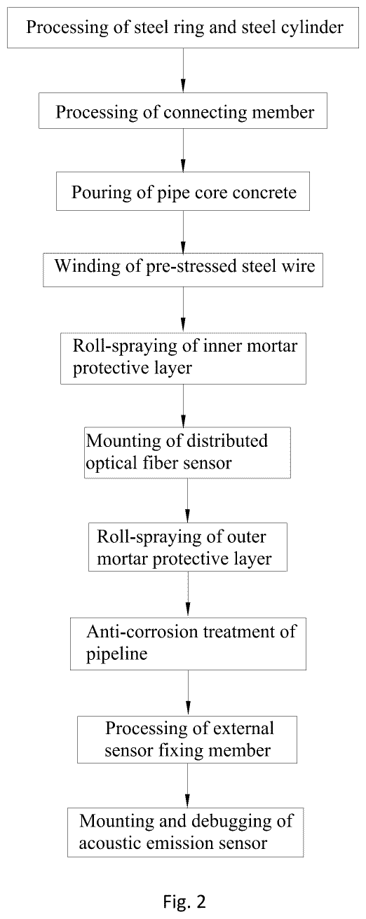

A corresponding construction flow of the novel pre-stressed concrete cylinder pipe with the pre-embedded acoustic emission sensor and the distributed optical fiber in the embodiment is as shown in FIG. 2, which specifically comprises the following steps.

In step (1), a socket steel ring and a spigot steel ring used for connecting a pipeline joint are manufactured. Meanwhile, the steel cylinder is manufactured, a steel plate is strip-rolled into a strip of 1.5 mm, and a seam of the steel plate is welded.

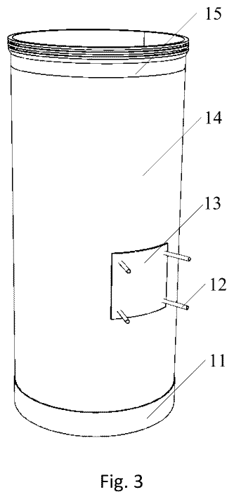

In step (2), the connecting member for connecting the steel cylinder with the external sensor fixing member is manufactured, as shown in FIG. 3. In FIG. 3, the socket steel ring 11 and the spigot steel ring 15 are respectively welded to two ends of the coil-welded cylinder 14 first. The connecting member for connecting the steel cylinder with the external sensor fixing member comprises a connecting hole 12 and a connecting plate 13. In First Embodiment, a diameter of the connecting hole 12 is 10 mm (less than a wire winding distance), and a bottom end of the connecting plate 13 is designed as an arc-shaped end surface matched with the steel cylinder 14, and a contact surface between the connecting plate and the steel cylinder is coated with a high-performance adhesive for connection

In step (3), a pipe core concrete is poured. The pipe core concrete is poured by a vertical vibration method, and an anchoring device for tensioning the pre-stressed steel wire is buried outside the pipe core concrete before the pouring operation. The cylinder connected with the socket steel ring 11, the spigot steel ring 15 and the connecting member is hoisted into an internal mold of pipe core pouring for accurate positioning, and the socket ring should be consistent with a working surface of a bottom mold. The concrete is stirred and mixed in strict accordance with a C55 concrete ingredient list, and the concrete is poured along inner and outer walls of a steel mold, so that the steel cylinder is embedded in the concrete, and a vibrator is started up during pouring to ensure dense pouring of the concrete. An inner diameter of the concrete pipe core is 2800 mm, an outer diameter of the steel cylinder is 2923 mm, and a thickness of the pipe core is 280 mm. Steam curing is carried out on the pipe core concrete after pouring, and when a strength of the concrete reaches 70% of a design strength, the next operation is implemented.

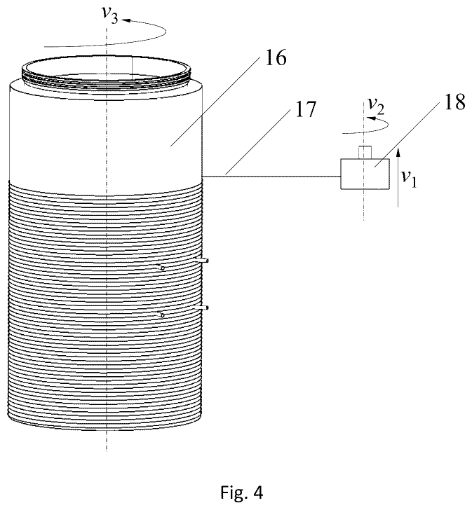

In step (4), the pre-stressed steel wire is wound. As shown in FIG. 4, the cured pipe core is erected on a pre-stressed wire winding table, and a layer of cement paste is sprayed on a surface of the pipe core before the wire winding operation. The pipe core 16 is driven to rotate at a speed v₃ by rotating a pedestal of the wire winding table, a stress generating device 18 rotates at a speed v₂ and moves forward along an axis of the pipe at a speed v₁, and the rotation speed v₂ of the stress generating device 18 is controlled to be less than the rotation speed v₃ of the rotary platform, so that a high-strength steel wire 17 with a diameter of 5 mm (with an elastic modulus of 205000 MPa and a tensile strength of 1570 MPa) generates a pre-stress of 1100 MPa (70% of the tensile strength of the steel wire), and is wound outside the pipe core concrete according to a pitch of 18 mm. A whole process of stress fluctuation also needs to be monitored in the wire winding process.

In step (5), the inner mortar protective layer is roll-sprayed. The mortar is configured according to a strength of M45 mortar, and a thickness of the inner mortar protective layer is not less than 10 mm.

In step (6), a distributed optical fiber sensor is mounted after the inner mortar protective layer is solidified. The first layer of roll-sprayed mortar needs to be polished and leveled before formal mounting, a tightly-sheathed sensing optical cable with an additional protective sleeve is initially fixed on a surface of the mortar during mounting, a glass fiber fabric is adhered outside the tightly-sheathed sensing optical cable, and a self-spraying paint and a 502 instant adhesive are used for fixation; and subsequently, the optical fiber is further fixed with a carbon fiber impregnating adhesive.

In step (7), the outer mortar protective layer and an epoxy coal tar pitch anti-corrosive coating are roll-sprayed. A ratio of outer mortar is the same as that of inner mortar, and a total thickness of a net mortar protective layer after roll-spraying is controlled to be not less than 30 mm

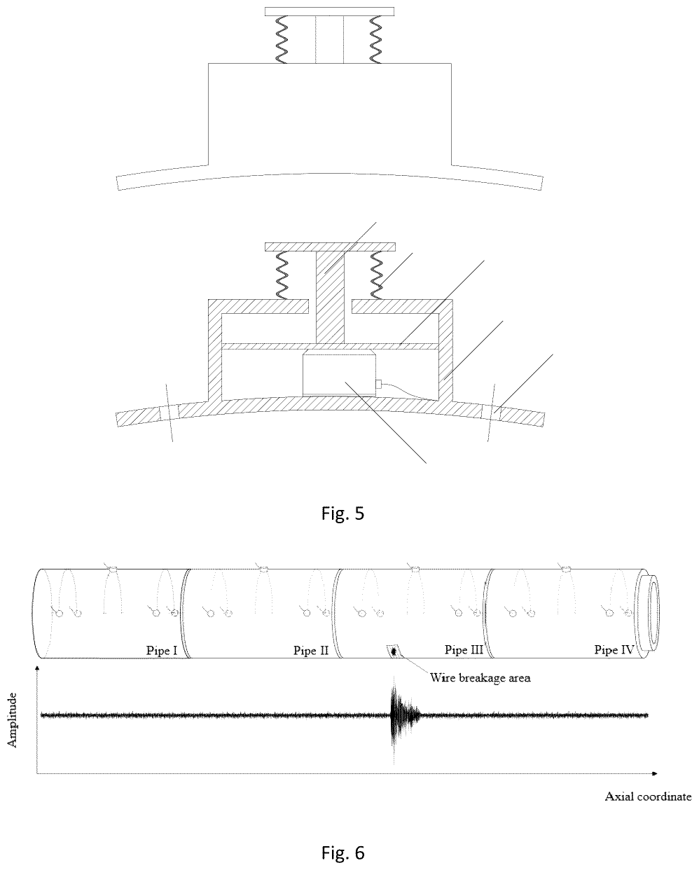

In step (8), the fixing member for mounting the external sensor is manufactured, and the external sensor fixing member is as shown in FIG. 5. The fixing member consists of a protective layer 22, a fixing hole 23, a sealing head 21, a strong spring 20 and a pressure head 19. When the pipeline is mounted on site, after hoisting the pipeline in place, the high-performance adhesive coupling agent is coated on the surface of the acoustic emission sensor 24, the pressure head 19 of the fixing member is opened and the sensor is mounted into the protective layer 22 of the fixing member, and the protective layer should have the functions of waterproof, moisture-proof, corrosion-proof and the like. The strong spring 20 is released to make the sealing head 21 fully press the acoustic emission sensor 24, and a bolt is used to fix the external sensor fixing member on the connecting hole 12 of the connecting member through the fixing hole 23. After the sensor is mounted in the fixing member for adhesion and fixation, the acoustic emission sensor and the distributed optical fiber are subsequently connected with an acquisition instrument and an optical fiber demodulation instrument respectively, so that a pipeline wire breakage event is monitored in real time.

A wire breakage signal acquisition and positioning effect test in First Embodiment is as follows.

In order to detect the effectiveness of the present invention in monitoring and positioning a wire breakage signal, four novel PCCP pipes manufactured by the method introduced in First Embodiment are used to carry out a wire breakage test, and the four pipes are connected through end-to-end sockets and spigots. An acoustic emission sensor with a peak sensitivity of 98 dB, a working frequency band of 200 kHz to 400 kHz and a resonant frequency of 335 kHz is used together with the novel PCCP pipe to carry out the wire breakage monitoring test. Each PCCP pipe is provided with the acoustic emission sensors in five positions respectively, and relative positions of the sensors are as shown in FIG. 6. A socket end and a spigot end are respectively provided with two acoustic emission sensors, a middle section is provided with one acoustic emission sensor, all the five sensors are arranged on the same side of a pipe waist, and the other side of the pipe waist is provided with a wire breakage area. By chiseling off the outer protective mortar, the pre-stressed steel wire is exposed, and the pre-stressed steel wire is corroded by using a corrosive solution until the wire is broken. The wire breakage signal monitored based on the distributed optical fiber is as shown in FIG. 6, and it can be judged from the figure that the wire breakage phenomenon is most likely to occur in a pipe segment III.

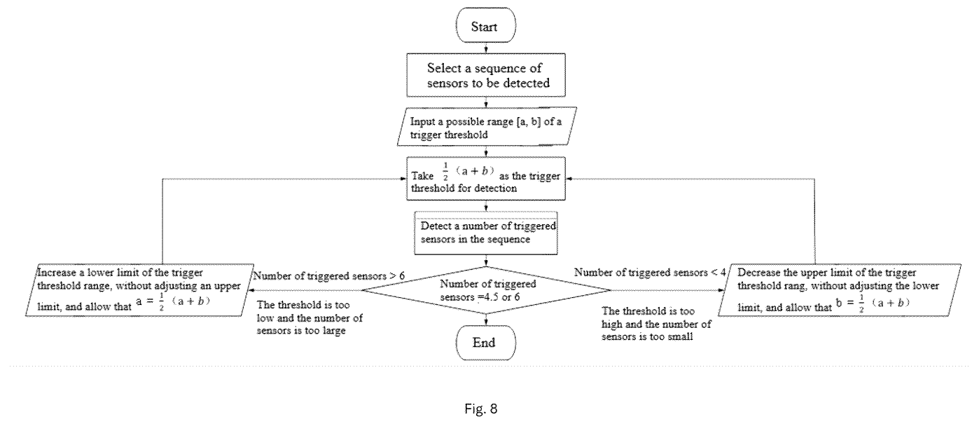

At this time, only an axial position of the wire breakage signal is acquired by monitoring through the distributed optical fiber, so that the acoustic emission sensor also needs to be called to accurately evaluate a circumferential position of the wire breakage signal. In the present invention, a number of acoustic emission sensors used for calculating the circumferential position of the wire breakage is selected by a method of dynamically adjusting a trigger threshold of the acoustic emission sensor, that is, a number of triggered sensors is respectively detected on left and right sides of the axial position of the wire breakage respectively through a given initial threshold. A specific implementing flow is as shown in FIG. 8 below.

In step (1), according to axial distances from an axial position where a broken wire is located to different sensors, 10 sensors with the closest axial distances from the position are selected, and the sensors are sorted according to the axial distances from small to large.

In step (2), a trigger threshold range of [0, 100 dB] is given according to experience, and an initial trigger threshold is setting as an average value of the range, that is, (0+100)/2=50 dB.

In step (3), synchronously recorded and selected acoustic emission waves in a sensor sequence are sequentially monitored by using the set trigger threshold, and when it is found that a number of triggered sensors in the sensor sequence is less than 4, it is indicated that the threshold is too high and the number of the triggered sensors is too small. Therefore, an upper limit of the trigger threshold range is adjusted, and a new range is set as [0, 50 dB]. The average value of the range, that is, [0+50]/2=25 dB, is taken as the trigger threshold for re-detection.

In step (3), when it is found from the detection that the number of the triggered sensors in the sensor sequence is greater than 6, it is indicated that the threshold is too low and the number of the triggered sensors is too large. Therefore, a lower limit of the trigger threshold range is adjusted, a new range is set as [25, 50 dB], and the average value of the range, that is, [25+50]/2=37.5 dB, is taken as the trigger threshold for re-detection.

In step (4), when it is found from the detection that the number of the triggered sensors in the sensor sequence is 5, the requirement for the number of the triggered sensors is met, the threshold adjustment is ended, and a position of the triggered sensor and corresponding P wave arrival time are recorded.

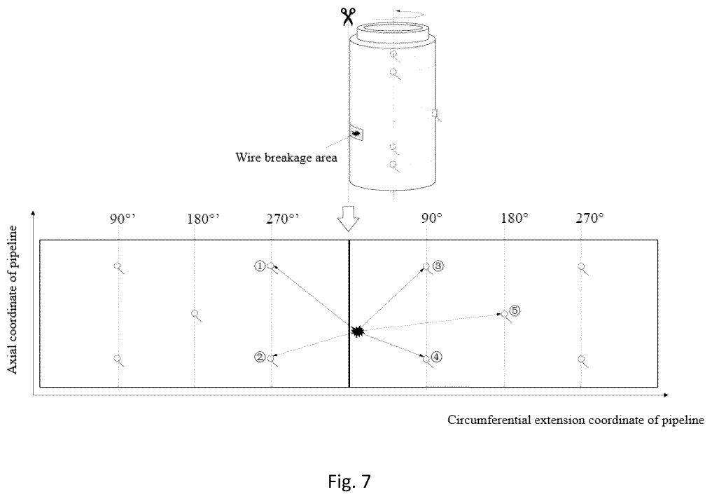

According to related studies, imaging that the pipeline is cut along a longitudinal line and extended into a corresponding plane according to the relative positions of the sensors, a cylindrical positioning problem of the pipeline structure may be transformed into a plane positioning problem. As shown in FIG. 7, a corrosive wire breakage test is carried out on the other side of the pipe waist, and according to a propagation principle of acoustic emission waves, sensors receiving the acoustic emission waves are four sensors in 90° and 270° positions on two sides in sequence, and a final single sensor in an 180° position opposite to the wire breakage position. After the pipeline is cut along the cutting line through imaging, a local coordinate system only considering the pipe segment III as shown in FIG. 7 is established, when the sensors at the socket and spigot ends are 500 mm away from the socket and spigot ends, relative coordinates of each sensor in a plane position may be calculated, plane coordinates of an actual wire breakage position are (10575.75, 2000.00), and plane coordinates and P wave arrival time of each sensor are as shown Table 1. Because the wire breakage occurs in a position close to a middle portion of the pipe segment III in this test, after the dynamic adjustment and calculation of the trigger threshold, all the five acoustic emission sensors arranged on the pipe segment III are triggered, and specific positions of the sensors are as shown in Table 1 and FIG. 7.

TABLE 1

| | X | Y | P wave |
|---|---|---|---|
| | coordinate | coordinate | arrival |
| Sensor | (mm) | (mm) | time (s) |
| \textcircled{1} sensor | 7916.81 | 4500.00 | 0.81 |
| \textcircled{2} sensor | 7916.81 | 500.00 | 0.68 |
| \textcircled{3} sensor | 13194.69 | 4500.00 | 0.80 |
| \textcircled{4} sensor | 13194.69 | 500.00 | 0.67 |
| \textcircled{5} sensor | 15833.63 | 2500.00 | 1.17 |

According to the propagation principle of the acoustic emission waves, position coordinates of a vibration source and coordinates of the sensor satisfy the following relational expression:

$$\sqrt{{( {x}_{i} - {x}_{0} )}^{2} + {( {y}_{i} - {y}_{0} )}^{2}} = {v}_{p} ( {t}_{i} - {t}_{0} ) \qquad ( 1 )$$

in formula (a), (x₀, y₀, t₀) respectively represent plane coordinates and vibration starting time of the vibration source, (xᵢ, yᵢ, tᵢ) respectively represent plane coordinates and P wave arrival time of an i^{th} sensor, and vₚ is a propagation speed of the acoustic emission wave in a pipe wall. Because the monitoring accuracy of the acoustic emission sensor is limited, and the propagation speed of the acoustic emission wave in each direction in the pipe wall is not necessarily uniform, for different sensors, the relational expression in formula (1) may not be strictly satisfied, and there are often some errors. Therefore, the solution of a vibration source estimation problem of the wire breakage position may be transformed into the solution of an optimization problem of minimizing a cumulative error of formula (1). The optimization problem may be rewritten into the following expression:

$$\begin{matrix}min {\sum }_{i = 1}^{5} \sqrt{{( {x}_{i} - {x}_{0} )}^{2} + {( {y}_{i} - {y}_{0} )}^{2}} - {v}_{p} ( {t}_{j} - {t}_{0} ) \\ s . t . \{ \begin{matrix}0 \leq {x}_{0} \leq 22000 \\ 0 \leq {y}_{0} \leq 5000 \\ 0 \leq {v}_{p} \\ 0 \leq {t}_{0}\end{matrix}\end{matrix} \qquad ( 2 )$$

A genetic algorithm is considered to solve the optimization problem herein, by inputting a mathematical model in formula (2) into a self-contained function in a genetic algorithm toolbox of MATLAB, the plane coordinates of the wire breakage position are solved to be (10588.710, 2016.278), and an error from the actual wire breakage position is 20.81 mm. It can be seen from the previous introduction that a diameter of the pipeline provided by the embodiment is 2800 mm and a length of the pipeline is 5000 mm, which shows that an error value of the wire breakage position is far less than an actual size of the pipeline structure, so that the positioning effect is good.

Those described above are merely the preferred embodiments of the present invention, and it should be pointed out that those of ordinary skills in the art may further make improvements and decorations without departing from the principle of the present invention, and these improvements and decorations should also be regarded as falling within the scope of protection of the present invention.

What is claimed is:

1. A manufacturing method of a novel pre-stressed concrete cylinder pipe with a pre-embedded acoustic emission sensor and a distributed optical fiber, comprising the following steps:
S1: manufacturing a socket steel ring, a spigot steel ring and a steel cylinder used for connecting a pipeline joint, and welding the socket steel ring and the spigot steel ring to two ends of the steel cylinder;
S2: manufacturing a connecting member for connecting the steel cylinder with an external sensor fixing member, and fixing the connecting member on the steel cylinder;
S3: pouring a pipe core concrete;
S4: erecting a cured pipe core on a rotary platform, and winding a pre-stressed steel wire;
S5: roll-spraying an inner mortar protective layer;
S6: mounting a distributed optical fiber sensor;
S7: roll-spraying an outer mortar protective layer;
S8: roll-spraying an epoxy coal tar pitch anti-corrosive coating;
S9: manufacturing a fixing member for mounted an external sensor, and fixing the fixing member on the connecting member by a bolt; and
S10: after hoisting a pipeline to the site for positioning, coating a high-performance adhesive coupling agent on a surface of the acoustic emission sensor, mounting the acoustic emission sensor in the fixing member for adhesion and fixation, and subsequently connecting the acoustic emission sensor and the distributed optical fiber sensor with an acquisition instrument and an optical fiber demodulation instrument respectively, so that a pipeline wire breakage event is monitored in real time.

2. The manufacturing method of the novel pre-stressed concrete cylinder pipe with the pre-embedded acoustic emission sensor and the distributed optical fiber according to claim 1, wherein the acoustic emission sensors are mounted on an upper side part of a pipe waist of a concrete pipe, and symmetrically arranged along an axial direction of the concrete pipe, and 5 to 9 acoustic emission sensors are mounted on a single pipeline.

3. The manufacturing method of the novel pre-stressed concrete cylinder pipe with the pre-embedded acoustic emission sensor and the distributed optical fiber according to claim 2, wherein the novel pre-stressed concrete cylinder pipe consists of an inner concrete, the steel cylinder, the connecting member, an outer concrete, the pre-stressed steel wire, the inner mortar protective layer, the distributed optical fiber, the outer mortar protective layer, the acoustic emission sensor and the external sensor fixing member in sequence from a pipe interior to a pipe exterior, the connecting member is fixedly connected with the external sensor, and the acoustic emission sensor is located on the external sensor fixing member and closely attached to the external mortar protective layer.

4. A wire breakage monitoring method of the novel pre-stressed concrete cylinder pipe with the pre-embedded acoustic emission sensor and the distributed optical fiber according to claim 2, comprising the following steps:
(a) carrying out a signal test before the pre-stressed concrete cylinder pipe leaves the factory, monitoring the pre-stressed concrete cylinder pipe by the distributed optical fiber and the acoustic emission device by simulating various environmental noises and wire breakage phenomena in a field monitoring process, establishing a signal sample database, and training a wire breakage signal identification model based on the database by a machine learning algorithm;
(b) after hoisting the pre-stressed concrete cylinder pipe to the site for mounting and positioning, coating the high-performance adhesive coupling agent on the surface of the acoustic emission sensor, mounting the acoustic emission sensor in the fixing member for adhesion and fixation, and subsequently connecting the acoustic emission sensor and the distributed optical fiber sensor with the acquisition instrument and the optical fiber demodulation instrument respectively;
(c) receiving in real time and synchronously recording signals of the optical fiber demodulation instrument and the acoustic emission acquisition instrument, inputting a signal of the distributed optical fiber acquired by monitoring into the wire breakage signal identification model for classification, and when the signal is identified as a wire breakage signal, recording an axial coordinate of a pipeline in which the signal appears;
(d) according to axial distances from the position to different sensors, selecting 10 sensors with the closest axial distances from the position, and sorting the sensors according to the axial distances from small to large;
(e) giving a trigger threshold range of [a, b] according to experience, and setting an initial trigger threshold as (a+b)/2;
(f) sequentially monitoring synchronously recorded acoustic emission waves in a sensor sequence by using the set trigger threshold, and when a number of triggered sensors in the sensor sequence is less than 4, allowing that b=(a+b)/2, and the threshold is (a+b)/2; and when the number of the triggered sensors in the sequence is greater than 6, allowing that a=(a+b)/2, and then updating the trigger threshold according to the formula (a+b)/2;
(g) repeating the step (f) until the number of the triggered sensors in the sensor sequence is 4 to 6, ending the adjustment of the trigger threshold, and recording current plane coordinates of each triggered sensor and P wave arrival time; and
(h) establishing the following mathematical model to solve a wire breakage position:
$$\begin{matrix}min {\sum }_{i = 1}^{n} \sqrt{{( {x}_{i} - {x}_{0} )}^{2} + {( {y}_{i} - {y}_{0} )}^{2}} - {v}_{p} ( {t}_{i} - {t}_{0} ) \\ s . t . \{ \begin{matrix}0 \leq {x}_{0} \leq {X}_{sup} \\ 0 \leq {y}_{0} \leq {Y}_{sup} \\ 0 \leq {v}_{p} \\ 0 \leq {t}_{0}\end{matrix}\end{matrix}$$
wherein: n is the number of the triggered acoustic emission sensors determined in the step (g), n is 4, 5 or 6, and vₚ is an acoustic emission wave velocity; (xᵢ, yᵢ) is a position of an i^{th} sensor, and tᵢ is P wave arrival time of the i^{th} sensor; t₀ is an appearance moment of the wire breakage signal, and (x₀, y₀) is an actual wire breakage position; and Xₛᵤₚ is a circumferential extension length of the pipeline, Yₛᵤₚ is an axial length of the pipeline, and (x₀, y₀) is a specific broken wire acquisition position.
